(19) United States
(12) Patent Application Publication
(10) Pub. No.: US 2008/0204792 A1
(43) Pub. Date: Aug. 28, 2008

(54) Method and System for Managing Information

(76) Inventor: William James Frost, New South Wales (AU)

Correspondence Address: RADER, FISHMAN & GRAUER PLLC, 10653 SOUTH RIVER FRONT PARKWAY, SUITE 150, SOUTH JORDAN, UT, 84095, US

(21) Appl. No.: 11/910,599

(22) PCT Filed: Apr. 7, 2006
(86) PCT No.: PCT/AU06/00464

§ 371 Date: Oct. 3, 2007

(30) Foreign Application Priority Data
Apr. 7, 2005 (AU) 2005901717

(51) Int. Cl. G06F 3/12; G06F 7/06; G06F 17/30

(52) U.S. Cl. 358/1.15; 707/5; 707/E17.017

(57) ABSTRACT

FIG. 4 depicts a preferred embodiment upon which a method for communication of data between a sender and a recipient is implemented. The sender utilises a first computer (50) in conjunction with a data correlation scheme (51) to prepare a form. The data correlation scheme (51) correlates available data fields with corresponding printing colours. In the preferred embodiment each of the printing colours are specified in the three digit RGB colour format. The sender prepares a form on which fields (52) and (54) containing data values are coloured in specific printing colours (53) and (57) in accordance with the data correlation scheme (51). The form is printed to a virtual computer, then sent as a data stream from the sender to the recipient. Once received at the recipient's computer (56), the invoice (55) is processed so as to extract the values associated with each of the printing colours (53) and (57). The recipient's computer (56) also has access to the data correlation scheme (51), either via a functionally identical version, as shown in FIG. 4, or via remote access to the original version. The recipient's computer (56) then processes the data correlation scheme (51) and the printing colours (53) and (57) so as to correlate the values with the chosen data fields (52) and (54). In this manner, two separate computer systems, (50) and (56), possibly utilising different applications that are not inherently compatible with each other, utilise the present invention for effective communication of data there between.

### FIELD OF THE INVENTION

The present invention relates to a method and system for managing information in a computing environment.

The invention has been developed primarily for streamlining business interactions between a distributor and a plurality of suppliers, and is described with reference to that application. However, it will be appreciated that the invention is not limited to this particular field of use, and is appropriate for managing information in a wide range of scenarios. For example, the invention has application in finance related situations, education systems, marketing, and many other areas where information is shared.

### BACKGROUND OF THE INVENTION

Any discussion of the prior art throughout the specification should in no way be considered as an admission that such prior art is widely known or forms part of common general knowledge in the field.

Companies expend a great deal of time, money and effort in extracting information stored in documents that are received in the course of trade. This information includes the likes of contact details, invoice particulars, deadlines, and financial reports. In general, a company has a desire to incorporate this information into its own information system for reference, reconciliation or further manipulation. It is therefore beneficial for a company to streamline the process whereby information in received documents is incorporated into an information system.

A rudimentary method for extracting information is manual data entry. This is time consuming, cost intensive, and inherently subject to inaccuracies. This being said, it is the only known solution in many circumstances.

A partial solution that is sometimes implemented is Optical Character Recognition (OCR). OCR attempts to recognise information in a document and digitally recreate this information as usable text. Known OCR systems are relatively inaccurate, resulting in a need for extensive quality control to minimise the risks stemming from inaccuracies. OCR is typically only suited to save data entry time by allowing for automated digital reproduction of information. That is, OCR generally does not provide a means for identifying specific important information in a document or protocols for meaningfully manipulating extracted information. Particular problems arise where only a portion of information is sought for extraction, for example a contact phone number or an invoice total. Moreover, OCR does not adapt to provide an inbuilt mechanism for manipulating extracted information. As a result of these deficiencies, OCR tends to require a relatively high level of physical instruction and supervision in order to provide for useful data extraction and/or manipulation.

Some companies have attempted to improve efficiency by agreeing upon standard formats and styles for correspondence. One example of this is where several companies adopt compatible information systems with complimentary send and receive interfaces. That is, a first company sends a document in a format that is adapted for recognition by a second company's information system. This solution is problematic in that the selection of an information system is generally one of personal preference insofar as a company is concerned, and is subject to external considerations such as cost and desired functionality. Further, a business is unlikely to adopt a particular information system simply to improve the efficiency of another's business.

The above issues are particularly relevant in circumstances where a distributor conducts business with a large number of suppliers. In most cases, the distributor operates an information system to keep track of orders that are sent to suppliers. The suppliers provide invoices in response to these orders, the invoices being formatted in accordance with the individual suppliers' discretion. The distributor generally has a desire to reconcile the details of invoices with the details of related orders prior to validating and paying the invoice. As such, the distributor engages in extensive data entry practices to incorporate the information on the suppliers' invoices into the distributor's information system. This information includes details such as invoice totals, order reference numbers, dates, order particulars, and the like. These data entry practices result in a per-transaction cost of validating an invoice, which those skilled in the art will recognise as high.

It would be preferable for the distributor to mandate a particular invoice format to streamline the validation process, and perhaps facilitate efficient use of OCR. Despite this, the nature of the relationship between the parties often rules out the making of such demands.

### SUMMARY OF THE INVENTION

It is an object of the present invention to overcome or ameliorate at least one of the disadvantages of the prior art, or to provide a useful alternative.

According to a first aspect of the invention, there is provided a system for managing information, the system including:

a table for associating one or more data ranks each with a respective digital attribute;

an interface for assigning a data rank from the table to a portion of information in a .document;

a processor responsive to the interface for identifying the associated digital attribute for the assigned data rank; and

an output device in communication with the processor for outputting the document in a data stream wherein the associated digital attribute is implanted in the portion of information.

Preferably, the system includes an input device for receiving the data stream. More preferably, the input device is responsive to the implanted attribute for identifying and extracting the portion of information. More preferably, the input device is responsive to the table for manipulating the extracted portion of information.

The input device preferably provides the extracted portion of information to any one or more of the following:

a database;

an information system;

a secondary document; and

a-communication package.

According to a second aspect of the invention, there is provided a method for managing information including the steps of:

associating one or more data ranks each with a respective digital attribute;

assigning a data rank to a portion of information in a document;

responsive to the assignment, identifying the associated digital attribute for the assigned data rank; and

outputting the document in a data stream wherein the associated digital attribute is implanted in the portion of information.

Preferably, the method includes the step of receiving the data stream. More preferably, this receiving step includes identifying and extracting the portion of information in response to the implanted digital attribute. For preference, the extracting step includes manipulating the extracted portion of information in response to the association between a data rank and respective digital attribute.

The extracted information is preferably provided to any one or more of the following:

a database;

an information system;

a secondary document; and

a communication package.

Preferably the or each digital attribute includes a chromatic marker. More preferably, the or each chromatic marker includes a variation of RGB colour. For preference, the variation is substantially visually imperceptible.

According to a third aspect of the invention there is provided a method for communication of data between a sender and a recipient, said method including the steps of:

providing a data correlation scheme whereby a plurality of data fields are respectively correlated with a corresponding plurality of printing colours;

printing an electronic form having at least one value within at least one preselected data field, said value being printed in a printing colour determined in accordance with said data correlation scheme;

communicating said electronic form from said sender to said recipient;

processing said electronic form so as to determine said value and said printing colour; and

processing said data correlation scheme and said printing colour so as to correlate said value with said preselected data field.

Preferably the printing colour is manually selectable by a user. More preferably, the printing colour is manually selectable by the specification of three numeric values in an RGB colour format.

In a preferred implementation the step of printing an electronic form includes the steps of:

preparing a blank form template;

defining a portion of the blank form template for receipt of said at least one value within at least one preselected data field;

formatting the portion in said printing colour;

inserting said at least one value into said portion; and

printing the form.

The method preferably includes the step of converting the colour or colours of said at least one value to a single standard colour.

According to a fourth aspect of the invention there is provided a communication processing method including the steps of:

providing a communications hub having information identifying a plurality of users adapted to utilise a data correlation scheme;

at said hub, receiving at least one electronic form from one of said users;

at said hub, processing said form to determine a recipient;

at said hub, processing said information to determine whether the recipient is adapted to utilise said data correlation scheme;

if the recipient is adapted to utilise said data correlation scheme, electronically forwarding said electronic form from the hub to the recipient.

According to a fifth aspect of the invention there is provided a communication processing method including the steps of:

providing a communications hub having information identifying a plurality of users adapted to utilise a data correlation scheme whereby a plurality of data fields are respectively correlated with a corresponding plurality of printing colours;

at said hub, receiving at least one electronic form from one of said users, said form including at least one value within at least one preselected data field, said value being printed in a printing colour determined in accordance with said data correlation scheme;

at said hub, processing said form to determine a recipient;

at said hub, processing said information to determine whether the recipient is adapted to utilise said data correlation scheme;

if the recipient is adapted to utilise said data correlation scheme, processing the form so as to extract said at least one value and said at least one preselected data field and electronically communicating said at least one value and said at least one preselected data field from the hub to the recipient.

In one embodiment, if the recipient is not adapted to utilise the data correlation scheme, a physical copy of the form is printed and posted from the hub to the recipient or a third party. In another embodiment, if the recipient is not adapted to utilise the data correlation scheme, the form is electronically returned from the hub to the sender.

A preferable implementation of the invention includes the step of archiving a copy of the electronic form at the hub.

According to a sixth aspect of the invention there is provided a transaction method for the purchase of goods from a seller by a buyer, said method including the steps of:

providing a data correlation scheme whereby a plurality of data fields are respectively correlated with a corresponding plurality of printing colours;

receipt by said seller of an order for goods by said buyer;

printing by said seller of a form including goods delivery data contained within at least one preselected data field, said goods delivery data being printed in at least one printing colour determined in accordance with said data correlation scheme;

communication of said form from the seller to a communications hub;

at said hub, processing said form to extract said goods delivery data;

at said hub, storing said goods delivery data in association with a unique identifier;

communication of said unique identifier from the hub to the seller;

physical printing by the seller of the unique identifier;

physical association of the unique identifier with the goods; and

dispatching of the goods by the seller for delivery to the buyer.

The transaction method preferably further includes the steps of:

receipt by the buyer of the goods and physically associated unique identifier;

communication of said unique identifier from the buyer to the hub; and

communication of the goods delivery data from the hub to the buyer.

### BRIEF DESCRIPTION OF THE DRAWINGS

Additional benefits and advantages of the present invention will become apparent to those skilled in the art to which this invention relates from the subsequent description of exemplary embodiments and the appended claims, taken in conjunction with the accompanying drawings, in which:

FIG. 1 is a schematic view of a system according to the invention;

FIG. 2 is a schematic view of a further embodiment of the system of FIG. 1;

FIG. 3 is a schematic view of a further embodiment of the system of FIG. 1;

FIG. 4 is a schematic view of a system according to the invention;

FIG. 5 is a schematic view of a communications hub according to the invention; and

FIG. 6 is a schematic view of a transaction method according to the invention.

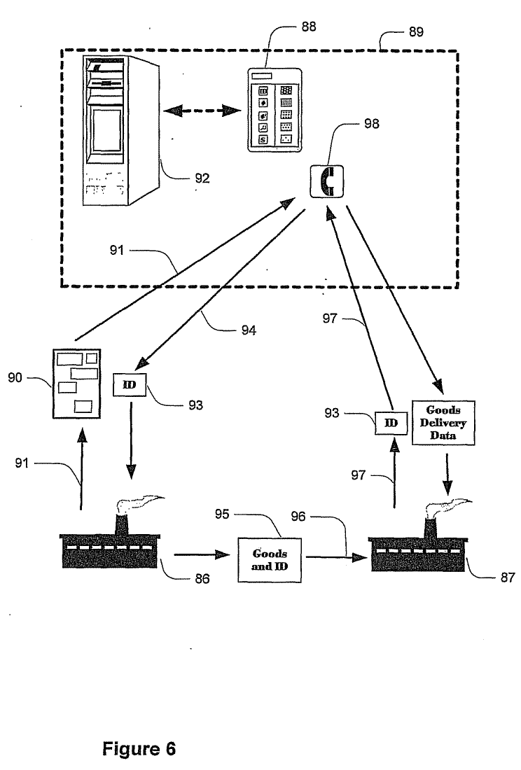

### DETAILED DESCRIPTION OF THE PREFERRED EMBODIMENTS

Referring to the drawings, it will be appreciated that, in the different figures, corresponding features have been denoted by corresponding reference numerals.

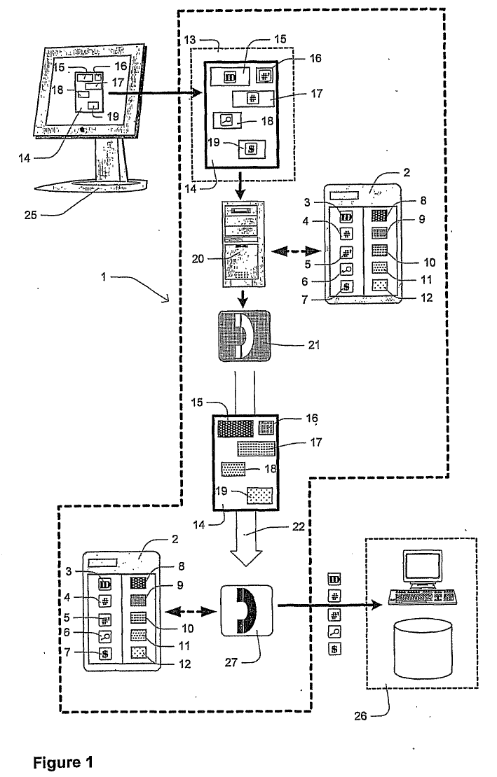

Referring initially to FIG. 1, there is provided a system 1 for managing information. System 1 includes a table 2 for associating one or more data ranks, denoted by reference numerals 3 to 7, each with a respective digital attribute, denoted respectively by reference numerals 8 to 12. An interface 13 is provided for assigning a data rank 3 to 7 from table 2 to a portion of information in a document. In the illustrated embodiment, the document is an invoice 14 including five portions of information, denoted by reference numerals 15 to 19. In other embodiments, alternate documents may be used, such as general correspondence, business cards, financial reports, education packages or bills. A processor 20 is responsive to interface 13 for identifying the associated digital attribute 8 to 12 for the assigned data rank 3 to 7. An output device, in the form of data streamer 21, is in communication with processor 20 and interface 13 for exporting invoice 14 in a stream 22 wherein the associated digital attribute is implanted in the portion of information.

In the present embodiment, table 2 is a relatively rudimentary SQL type database. As such, table 2 handles queries supplied by processor 20. More specifically, processor 20 provides a signal indicative of a data rank 3 to 7 and receives a signal indicative of the associated attribute 8 to 12. In other embodiments, alternate combinations of appropriate hardware and/or software may be used to perform the functionality of table 2.

It is noted that processor 20 should be able to identify documents intended to be managed using system 1. Other documents are not processed by processor 20, and as such are not exported by data streamer 21. Such documents would be handled in the conventional manner only.

Table 2 includes five data ranks, being data ranks 3 to 7. In other embodiments alternate quanta of data ranks are used, this being selected by reference to the desired functional implementation of system 1. For example, in some embodiments only a single data rank is used. Each data rank 3 to 7 is indicative of a particular type of information typically found on an invoice such as invoice 14. In this exemplary embodiment:
Rank 3 is indicative of an invoice provider.
Rank 4 is indicative of a order reference number.
Rank 5 is indicative of an invoice reference number.
Rank 6 is indicative of a goods/services description.
Rank 7 is indicative of an invoice total.

For the purpose of the present specification, a digital attribute refers to a digitally recognisable marker. A digital attribute can be implanted into a portion of information in a variety of ways, including modifying textual information to inherently carry the attribute within characters, as well as applying a digital marker over or around a portion of information to define a digitally recognisable field that contains the portion of information. In some situations, it is advantageous for digital attributes to be substantially imperceptible to the human eye, although readily recognisable by digital means. The benefits of such an approach will be highlighted in the present disclosure. Despite this, the fundamental notion is that a digital attribute involves a marker recognisable by a digital recognition device, regardless of whether it is recognisable by the human eye. To this end, in some embodiments the digital marker may render the information difficult or even impossible to read by the human eye.

In the drawings, digital attributes are graphically represented by differing shades for the purposes of schematic illustration. It is appreciated that, in some embodiments, implanting a digital attribute may involve shading a portion of information to define a digitally recognisable field. Despite this, in other embodiments implanting a digital attribute may involve modifying textual characters to inherently carry digital markers. The shading in the drawings is for illustrative purposes only and by no means limiting to the scope of the invention or embodiments thereof. Shading is merely used to graphically indicate that a portion of information is marked with a digital attribute from table 2.

In the present embodiment, each digital attribute is indicative of a text colour. More specifically, the digital attribute includes a chromatic marker indicated by an RGB value, each chromatic marker including a substantially visually imperceptible variation of RGB colour. Those skilled in the art will appreciate that RGB colour is regularly classified in the form (x, y, z), where x represents the red content, y represents the green content, and z represents the blue content. Black is traditionally represented as (D, 0, 0). Incremental variation of one or more of the values of traditional black results in an incrementally adjusted chromatic variation of black. Such variations are not readily perceptible by the human eye, but are recognisable using digital recognition means. In the present example, table 2 associates each data rank with a specific RGB value for text colour. In particular:
Rank 3 is associated with (1, 0, 0)
Rank 4 is associated with (0, 1, 0)
Rank 5 is associated with (0, 0, 1)
Rank 6 is associated with (1, 1, 0)
Rank 7 is associated with (1, 0, 1)

In this example, implanting a digital attribute into a portion of information effectively involves colouring the text that makes up the relevant information with the relevant RGB value.

Other embodiments that make use of similar digital attributes are modified somewhat. For example, RGB variations are not necessarily strictly numerical—that is, a particular rank may be associated with (1, 0, A). In some embodiments, “A” might represent a variable. In further embodiments, the quality of each number in a RGB value is relevant. For example, a particular rank may be associated with any RGB value in which the final digit of each number is “2”—for example (12, 142, 232), (82, 2, 192) or (252, 2, 2). It will be recognised that the latter of these represents a vivid red. There is a large amount of scope for modification in selecting digital attributes even within the present example of RGB usage. Further, alternate colour systems may be used, such as CMYK colour, or the like. The underlying notion is that any colour can be digitally represented in a digital system, and processing may be carried out based on a digital analysis of the colour.

In a further embodiment, the digital attribute used is dottagging. Dot-tagging involves use of an array of small dots arranged in a specific array within each character of text. For example, rank 3 might be associated with three dots arranged in an equilateral triangle, whilst rank 3 is associated with four dots in a vertical linear path. The dots are sufficiently small as to be visually unrecognisable, however a digital recognition means picks them up when scanning text.

In some embodiments where the digital attribute is applied directly to textual characters, the first and last characters may be provided with a special attribute to mark the beginning and end of an important string of information.

In a further embodiment, the digital attribute used is field shading. Field shading is a process where a digital schema is placed over information to define digitally recognisable fields. Each digital attribute includes a unique schema such that the purpose of the information in each defined field is given a meaning in line with the associations in table 2. In some embodiments, applying a digital schema can be viewed as a digital adaptation of highlighting. That is, a portion of information is digitally highlighted by a particular colour, shade, or other digitally recognisable means, to define a field around that portion of information. It will be appreciated that the particular colour, shade, or other digitally recognisable means is a digital attribute in table 2, and as such is associated with a particular data rank. In some embodiments, it is preferable for the digital highlighting to be substantially visually imperceptible. It will be appreciated that traditional RGB white is represented by (255, 255, 255). As such, it may be desirable to highlight with white variations such as (255, 255, 254).

In some embodiments, implanting a digital attribute includes implanting hidden information into the document. Hidden information may be implanted as code coloured in a subtle white variation, and this may identify the rank and location of portions of information. For example, an invisible code might provide relative spatial coordinates to define fields including portions of information.

In the embodiment of FIG. 1, interface 13 is a utility that is adapted for integration into existing accounting software package 25 that is used to produce invoice 14. Interface 13 modifies the operation of software package 25 for the purposes of system 1.

To use system 1, software package 25 is used to create invoice 14 in the conventional manner. It will be appreciated that the portions of information 15 to 18 on invoice 14 are arranged in accordance with formatting selections made as part of the normal operation of software package 25. In relation to invoice 14:
Portion 15 is the invoice provider.
Portion 16 is the order reference number.
Portion 17 is the invoice reference number.
Portion 18 is the goods/services description.
Portion 19 is the invoice total.

Invoices produced by alternate software packages include the same information portions arranged in an alternate manner.

Interface 13 is responsive to the accounting software package for assigning the appropriate data rank 3 to 7 to each portion of information 15 to 19. It will be appreciated that this responsiveness is a result of the integration process. In some embodiments it is necessary to manually identify the data rank for each portion to enable interface 13 to carry out the assignment.

In further embodiments, alternate interfaces may be used. For example, in some embodiments interface 13 is a standalone application that receives a document and assigns a data rank to a portion of information in response to manual digital section of the text that makes up that portion of information, much like conventional text selection in word processing software. In other embodiments, interface 13 is a standalone application that receives a document and assigns a data rank to a portion of information in response to the location of that portion on the document. For example, interface 13 is initialised to recognise the format of invoice 14 and assign the appropriate data ranks to information portion based on their position.

Once interface 13 has assigned the appropriate data ranks 3 to 7, processor 20 identifies the associated digital attributes 8 to 12 for the assigned data ranks 3 to 7 with reference to table 2. Following this, data streamer 21 exports invoice 14 in stream 22 wherein the associated digital attributes 8 to 12 are implanted in the relevant portions of information 15 to 19. In this embodiment, both of processor 20 and data streamer 21 are software utilities that are integrated into software package 25. In some embodiments, data streamer 21 is a distinct software application. In such embodiments, invoice 14 is prepared in the conventional manner using software package 25, and subsequently sent out using data streamer 21. It will be appreciated that this provides for a further review of invoice 14 prior to it being sent. That is, the party preparing the invoice has a final chance to review the document before it leaves their control on the path to the intended recipient. This is particularly useful where one division of a company prepares invoices, and another division is responsible for checking the invoice, approving the invoice, and sending it out.

It will be appreciated that, in the present example, when invoice 14 is exported in stream 22:
The text in portion 15 is coloured (1, 0, 0).
The text in portion 16 is coloured (0, 1, 0).
The text in portion 17 is coloured (0, 0, 1)
The text in portion 18 is coloured (1, 1, 0).
The text in portion 19 is coloured (1, 0, 1)

In the present embodiment, stream 22 is a digital communication stream wherein invoice 14 is in a Portable Document Format (PDF). In other embodiments, stream 22 is indicative of a digital document format that is suitable for email or other electronic transfer, such a JPEG, PDF, TIFF or GIF. As such, for the purposes of this specification, a stream is a format that is either suitable for communication, or a communication means in itself. In still further embodiments, stream 22 includes traditional document printing and mailing, however, in such embodiments appropriate printing and scanning components are necessary to enable implanting and recognition of digital attributes in documents. For example, if subtle RGB variations are used, a printer capable of outputting a document in which the text is digitally identifiable as being of a specific RGB colour, mindful of the slight nature of variations. As such, in embodiments where data stream 22 includes traditional printing and mailing, it may be preferable to utilise alternate digital attributes such as dot-tagging.

It is mentioned that, in certain embodiments, stream 22 is electronic and used in parallel to conventional printing and mailing. In such embodiments, it is by no means necessary for the digital attribute to be visible in the printed document as well as the digital stream. This is particularly relevant in situations where the digital attributes include a virtual schema of white variations, as discussed above.

Invoice 14 is sent in stream 22 to a recipient, being the debtor of invoice 14. In the present embodiment, invoice 14 is also sent in the conventional manner—in this example being registered mail—for the sake of confirmation. It will be appreciated that this is not always necessary. It is mentioned that, in some embodiments, the invoice 14 sent in the conventional manner may be different from the invoice 14 in stream 22. For example, some information may be recognised and removed when printing invoice 14 in the conventional manner. As such, extra information might be passed on invoice 14 in stream 22. An example of this would be text coloured in a white variation, such as (255, 254, 254).

The debtor of invoice 14 operates an accounting system 26, which is not necessarily compatible with accounting package 25. That is, accounting system 26 is not inherently adapted to receive invoice 14.

The debtor has an input device in the form of receiver 27. In this embodiment, receiver 27 is considered as part of system 1, however, in other embodiments receiver 27 may be considered as being external to system 1. Receiver 27 is responsive to the implanted attributes 8 to 12 in invoice 14 for extracting the portions of information 15 to 19. Extracting in this sense does not refer to physical removal, but electronic recognition and external reproduction.

In the present embodiment, receiver 27 is a standalone unit including hardware and software components for receiving and processing stream 22, and communicating information to accounting system 26. In other embodiments, receiver 27 may be integrated into accounting system 26.

Receiver 27 has access to a functional reproduction of table 2. In some embodiments both processor 20 and receiver 27 access the same table 2 by way of a wide area network or internet connection. Receiver 27 is responsive to table 2 for manipulating the extracted portions of information 15 to 19. In this embodiment, manipulating the extracted portions of information 15 to 19 includes incorporating the information into accounting system 26. To this end, receiver 27 includes the necessary software utilities to facilitate communication with the existing accounting system. It will be appreciated that there is no need for accounting system 26 to be compatible with accounting software package 25.

In the present embodiment, receiver 27 also incorporates other information about invoice 14 into accounting system 26. This includes the date and time receiver 27 receives invoice 14. Other forms of additional information may include an identifier indicative of the provider of data stream 22, or information obtained from an external database, such as a database containing information about various users of system 1.

To summarize, an invoice 14 is prepared using existing accounting software package 25 in the conventional manner. System 1 acts to automatically digitally adjust invoice 14 using attributes 8 to 12, and send the adjusted invoice 14 to the debtor in a stream 22. Receiver 27 then automatically extracts the important information from invoice 14 and functionally incorporates this information into accounting system 26. Those skilled in the art will recognise this as a useful means of interfacing inherently incompatible account management infrastructure.

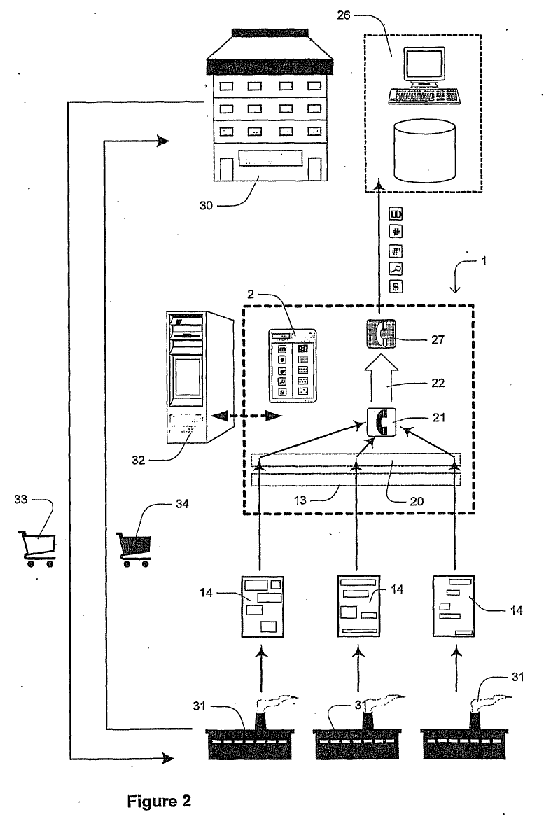

FIG. 2 schematically represents an exemplary implementation of system 1. In this embodiment, system 1 interfaces a single distributor 30 with a plurality of suppliers 31. A major impetus of this embodiment is validating invoices from suppliers 31. “Validating” an invoice refers to the process whereby an invoice is received, checked, and passed for payment. It will be appreciated that a desire exists to ensure an invoice is fairly based upon goods that were previously ordered. Further, a desire exists to ensure the goods were received. Traditionally, validating invoices is an expensive process for a distributor 30, the cost being felt on each transaction. It is also time consuming, and may result in less than desirable cash flow rates for suppliers 31. Although the cost for each transaction is sometimes relatively small, the validation process is particularly expensive when viewed from a long-term or wide-scale perspective.

An external administrator 32 implements and administers system 1. In other embodiments, distributor 30 takes on the tasks of administrator 32. This being said, the use of administrator 32 improves the cost effectiveness of system 1, especially considering that administrator 32 is able to administer a system 1 for a plurality of distributors. In the present embodiment, administrator 32 is a company that provides the services associated with system 1. The dashed line between the graphical representation of administrator 32 and system 1 is used to indicate that administrator 32 has control over the management of system 1, and is primarily responsible for the implementation. It is appreciated that, in reality, many of the components of system 1 would reside in actual servers that are maintained by administrator 32.

In other embodiments, administrator 32 is a computer system, a person, a department within distributor 30 or suppliers 31, or a combination of these or other things.

Administrator 32 is responsible for initialising the hardware and software for system 1. In some embodiments, this includes developing the necessary utilities to integrate the necessary components of system 1 into the accounting packages of suppliers 31. Administrator 32 is also responsible for providing these utilities to suppliers 31 and ensuring that the integration process is relatively unobtrusive to suppliers 31. Those familiar with the art will understand that the success of implementing a system such as system 1 is, to some degree, dependant on the cooperation of suppliers 31. As such, it is often desirable to be as unobtrusive and undemanding as possible. In some embodiments this includes providing accounting software packages and computer systems to a supplier 31 that did not previously have such infrastructure.

In FIG. 2, system 1 is schematically shown as being entirely separate from suppliers 31. Despite this, it is appreciated that some functionalities of system 1 may be integrated into the information systems of suppliers 31.

Distributor 30 places orders 33 with suppliers 31, these orders including respective details. These details include:
The supplier 31 to whom the order is directed.
A order reference number.
A description of the ordered goods.

When placing an order 33, the details are recorded in the accounting system 26 of distributor 30.

In general, a supplier 31 receives an order 33, and in response provides the ordered goods 34 to distributor 30. As part of the regular business practice of distributor 30, the details of any received goods 34 are entered into accounting system 26. These details include particulars such as the sender's identifier, date received, goods received, and order reference number.

Simultaneously with or soon after dispatching a consignment of goods 34, the relevant supplier 31 also prepares an invoice 14 for those goods. As was the case with for example of FIG. 1, invoice 14 includes five portions of information, respectively including:
An identifier of the invoice provider.
A order reference number—this being the order reference number provided by distributor 30 as part of order 33.
An invoice reference number.
A description of the invoiced goods.
The invoice total.

It will be noticed that, in FIG. 2, the invoices 14 produced by each of the suppliers 31 differ in format. Further, each is produced using a different accounting software package. Nevertheless, they each include all five portions of information, these portions of information being relatively standard across all invoices. As such, given the working of system 1, the format of invoice 14 is not of concern, as is the case in many known OCR systems.

The invoice is prepared in the conventional manner, and automatically processed by system 1 under the supervision of administrator 32. That is, to summarize what has been described above in relation. to FIG. 1, the invoice is received in interface 13 where each portion of information is assigned with a data rank, the associated RGB attributes are determined by processor 20 with reference to table 2, and the adjusted invoice is sent in stream 22. Receiver 27 then extracts and processes the portions of information by reference to table 2. Administrator 32 then communicates the information to accounting system 26. As such, accounting system 26 includes all five portions of information for each invoice provided by a supplier 31. It will be recognised that this information is acquired by accounting system 26 relatively quickly and cost effectively, particularly when compared with data entry alternatives.

In due course, three sets of information will be acquired by accounting system 26 for an order 33. These are:
The details of order 33.
The details of received goods 34.
The details of invoice 14.

The order reference number conveniently ties the three sets of information together, being constant throughout. In some embodiments, accounting system 26 does not use a order reference number, in which case alternate arrangements for linking the information for orders 33, goods 34 and invoices 14 are implemented.

Having this information allows accounting system 26 to validate invoice 14. In the present embodiment, validating an invoice involves reconciling these three sets of information. “Reconciling” refers to the process whereby like types of information across the three sets are compared to ensure they match. For example, the order, invoice and goods received should share common identifier of the invoice provider, order reference number and description of goods.

As a specific example of the validation procedure for the embodiment of FIG. 2, an invoice 14 is received in system 1 with the following information, which is acquired by accounting system 26 via system 1:
Invoice provider=Joe's Supplies.
Order reference=123.
Invoice reference=456.
Goods=seven widgets.
Invoice total=$500

In a normal case, accounting system 26 will have details of an order 33 made out to Joe's Supplies, identified by order reference 123, for seven widgets. Further, system 26 will have, or obtain in due course, details of a delivery of goods 34, in the form of seven widgets, from Joe's Supplies. In such a case, accounting system 26 is satisfied that an order was placed, and that the correct goods were received. As such, invoice 14 is validated and the relevant procedures to pay invoice 14 are commenced.

It is appreciated that, in many cases, invoice 14 is received prior to goods 34. This often occurs where an invoice 14 is delivered via system 1 at the same time as supplier 31 dispatches goods 34. In these circumstances, system 26 is responsive to receiving details of the delivery of goods 34 for validating invoice 14.

It is noted that; in some embodiments, correctly reconciling the details of an order 33 and an invoice 14 may be sufficient for validating that invoice. In these embodiments, problems regarding goods 34 not being delivered may be followed up at a later stage.

In some circumstances, the details acquired from order 33, goods 34 and invoice 14 are inconsistent. For example, where an invoice 14 is received and there is no record of a corresponding order. In such situations, a problem is identified and the relevant invoice is not validated as a matter of course. The subsequent procedure may vary in different embodiments, but generally involves escalating that invoice for further investigation. Similar practices are used to handle enquiries from suppliers 31 about the status of particular invoices 14. It will be noticed that accounting system 26 includes substantially all of the information required to investigate escalated invoices.

In this embodiment, administrator 32 maintains records of the operation of system 1 for the purposes of auditing and resolving disputes. This includes the information extracted from invoices 14, which is stored in a database. Further, administrator 32 maintains a digital storage facility containing the necessary data to reproduce an invoice 14 in the form that it was prepared by a supplier 31—an original copy. This alleviates, to some extent, the need for distributor 30 to maintain original copies. of invoices 14 in a readily accessible form. Should an issue arise, distributor 30 places a request to administrator 32 for original copies of particular invoices. As part of the request, distributor 30 provides any one or more of the invoice number, the name of the supplier 31, the goods 34, the order reference number, the date the invoice was received, and the invoice number. It is appreciated that the more information provided, the higher the probability that a request is indicative of a unique invoice. This being said, it is often desirable to obtain original copies of all invoices for a certain time period, or for a certain supplier 31. As such, only a predetermined selection of information may be required for the request.

In the illustrated embodiment, the reconciling of an invoice 14 is carried out in accounting system 26, on the basis of the information provided by administrator 32 through system 1. Despite this, in some embodiments administrator 32 may take on the role of reconciliation. As such, details of orders 33 are provided to administrator 32, which may involve orders 33 being sent to distributors 30 via a reverse communication aspect of system 1. A similar process is implemented in relation to the delivery of goods, such that administrator 32 has sufficient information to process invoice 14. Once reconciliation is completed, administrator 32 passes invoice 14 to distributor 30 for payment. This form of arrangement is particularly useful in reducing the burden on accounting system 26, which might not inherently provide a reconciliation processor in all circumstances.

It will be appreciated that system 1 provides an improved interface between distributor 30 and suppliers 31 for the purposes of invoice reconciliation. It reduces the cost and effort expended by distributor 30 in reconciling invoices, and improves the cash flow for suppliers 31.

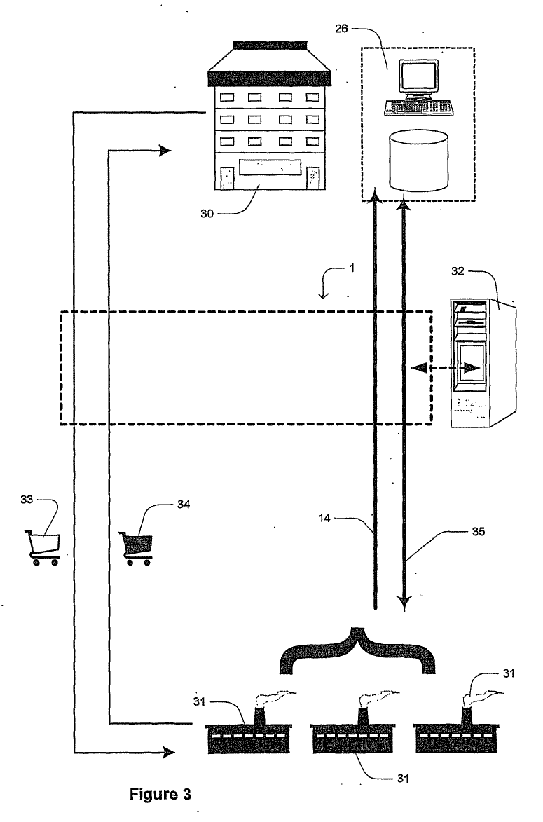

System 1 is easily modified for integrating parties for purposes other than handling invoices. FIG. 3 is illustrative of this, in that all communication between distributor 30 and suppliers 31 pass through system 1 for data management purposes. In particular, general communications 35 pass through system 1 in both directions. It will be appreciated that in such an embodiment, system 1 is adapted to provide additional benefits to both distributor 30 and suppliers 31. Indeed, receiving information and efficiently processing that information into a local information system is a concern from distributor 30 and suppliers 31 alike. Effectively, system 1 could be used to interface virtually all of the information and data transfer systems of the respective parties to facilitate very convenient sharing of information. As such, system 1 is used to overcome the hurdles associated with incompatible information systems, as well as facilitating the efficient handling, manipulation and general management of information.

It will be appreciated from the disclosure of the above embodiments that system 1 may be used to promote a beneficial electronic interchange between two or more parties. By subscribing to an administrator 32 for the provision of system 1, an entity is in a position to share information with other entities in an efficient manner. Administrator 32 is in a position to modify a system 1 to take care of particular information interchanges, such as invoices 14.

In a further embodiment, system 1 may be used to manage contact details. It is well known for a company to make use of personalised stationery, which includes the company's name, address, and telephone number. The company's personalised stationery is used for the purposes of correspondence. It is appreciated that such stationery generally includes further information, such as facsimile numbers, email addresses, Business Registration Numbers, and the like. Although system 1 is capable of handling such information, these details are neglected for the sake of simplicity in the present example.

For the sake of this example, system 1 is described in relation to digitally constructed stationery for the purposes of electronic correspondence. Those skilled in the art will appreciate the necessary modifications to implement system 1 for use with paper stationery and correspondence. In some embodiments this may involve the use of specialised printers and scanners, which are known in the art.

In this embodiment, system 1 includes a software application for producing stationery. Table 2 is a component of this software application, and includes three data ranks, these being indicative of a company name, address, and telephone number. Table 2 associates each data rank with a digital attribute, in the form of RGB variations of black (1, 0, 0), (0, 1, 0) and (0, 0, 1) respectively.

Interface 13 is also a component of the software application, in the form of an editor that allows for the creation of personalised stationery and/or the modification of existing stationery. A user of system 1 creates or modifies stationery using interface 13, and in doing so identifies the portions of information that are indicative of the company's name, address, and telephone number. It will be appreciated that this process may be somewhat improved by using appropriate software components and/or process wizards in some embodiments.

The software application also includes processor 20 and data streamer 21. Once the user has finished creating or modifying the stationery, processor 20 identifies the appropriate digital attributes from table 2, and data streamer 21 outputs the adjusted stationery in a stream 22. In this case, stream 22 is a digital stationery template that is used to apply the adjusted stationery to digital correspondence. In the particular example of the present embodiment, the user produces correspondence in the conventional manner, and then outputs the correspondence into a PDF. This PDF includes the adjusted stationery. In other embodiments, the adjusted stationery may be imported into a word processor and added to correspondence using the word processor. It will be appreciated by those skilled in the art that other methods for adding the adjusted stationery to correspondence can be used.

The correspondence containing the adjusted stationery is sent in the conventional manner, in this embodiment being email. For the sake of the present example, the recipient of the email uses a complimentary software application that includes receiver 27. This is not necessarily the same as the earlier software application—for example, the complimentary software application may be “freeware” in some embodiments, and does not necessarily provide the functionality to create or modify stationery.

Receiver 27 recognises receipt of the correspondence containing the adjusted stationery. In the present embodiment, recognition occurs when the correspondence is viewed, however in other embodiments recognition occurs when the email is received. It will be appreciated that receiver 27 may integrate with third party applications for the purpose of recognition. Upon recognising receipt of correspondence containing adjusted stationery, receiver 27 extracts the company name, address and telephone number and stores these in a contact database. If the contact database already includes identical details, new entries are not made. The contact database may be adapted for synchronisation with other contact databases, including Customer Relations Management (CRM) systems and electronic address books. In some embodiments receiver 27 may communicate the details directly to an external contact database, such as one included in a CRM system.

It will be appreciated that this implementation of system 1 allows for contact details to be automatically derived from correspondence. This is valuable both to the sender, who gains valuable customer information, and to the recipient, who saves time and effort in avoiding data entry.

In further embodiments, system 1 is used to improve the efficiency of existing OCR hardware and/or software. An example includes an implementation wherein digital highlighting is used. In this embodiment, each data rank is indicative of a type of information, and each data rank is associated with a digital highlighting colour in table 2. In this embodiment, interface 13 is part of a standalone application, and includes a graphical user interface (GUI). A user views the document in the GUI, and digitally highlights portions of information using appropriate colours based on the nature of the information. This will be recognised as assigning a data rank from table 2 to a portion of information in the document, in combination with processor 20 being responsive to the interface for identifying the associated digital attribute. Once the user has finished viewing and highlighting the document, the document is exported in a data stream 22 wherein the highlighting is present. The document is then passed to a receiver 27, which extracts and manipulates the information in accordance with the digital highlighting.

In some further embodiments, system 1 is used to implant a digital attribute into a portion of a document that is adapted to carry information, but that does not necessarily yet carry traditional information in the form of textual data. The document does, however, implicitly contain information indicative of the existence of one or more fields. One implementation is in the field of payment processing, for example in telephone bills. Payment forms are prepared by a plurality of telephone companies, each with their own unique formats. Each form includes a portion for a recipient to enter a credit card number and a portion to enter the expiry date of that credit card. These portions are marked by digital attributes to define digitally recognisable fields. The digital attributes are associated with appropriate data ranks in table 2. As a result, when the completed payment form is returned, the telephone company is able to extract the. credit card number and expiry dates, and thus process the payment using a standard credit card processing system.

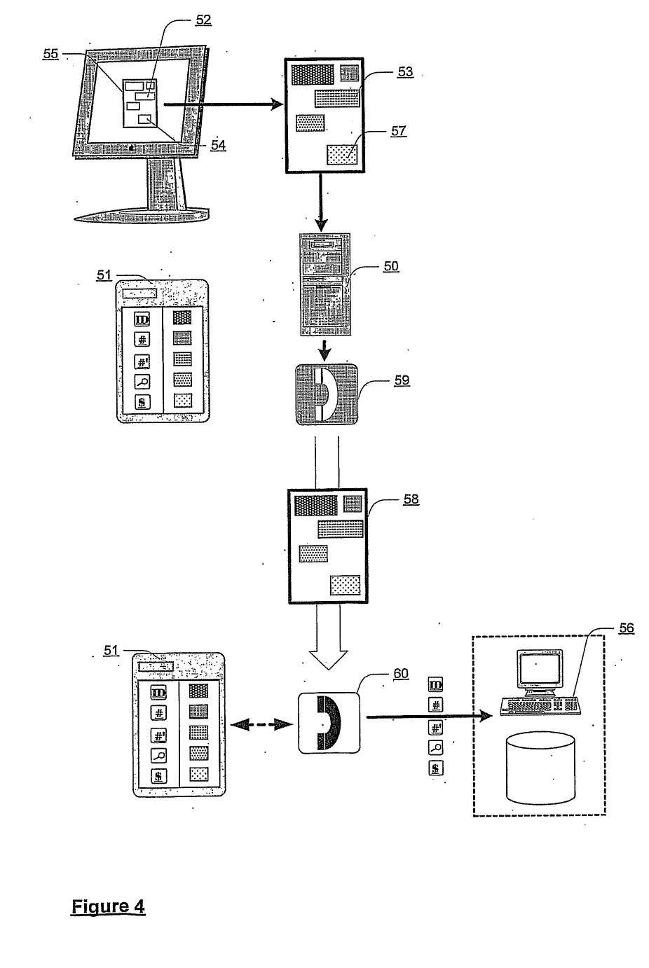

FIG. 4 depicts an embodiment upon which a method for communication of data between a sender and a recipient is implemented. The sender utilises a first computer 50 in conjunction with a data correlation scheme 51 to prepare a form. The data correlation scheme 51 correlates available data fields (as shown in the left hand column) with corresponding printing colours (as shown in the right hand column). Each of the printing colours are specified in the three digit RGB colour format. For the sake of a running example with reference to this embodiment, an invoice-type form having two fields, a “debtor” field 52 and an “amount payable” field 54 will be considered. In this example, the data correlation scheme 51 correlates the “debtor” field 52 with RGB printing colour (0,0,1) 53 and the “amount payable” field 54 with RGB printing colour (0,1,0) 57. Both of these RGB printing colours are visually imperceptible from pure black, which is represented by (0,0,0).

When the sender wishes to prepare and print a form, such as an invoice 55, the user commences by preparing a blank form template. A first portion of the template is reserved for receipt of a value for the “debtor” field 52 and a second portion of the template is reserved for receipt of a value for the “amount payable” field 54. The sender then refers to the data correlation scheme 51 and determines that the “debtor” field 52 is correlated with RGB printing colour (0,0,1) 53. Hence, the sender manually selects RGB printing colour (0,0,1) 53 for the first portion of the template. The sender again refers to the data correlation scheme 51 and determines that the “amount payable” field 54 is correlated with RGB printing colour (0,1,0) 57. Hence, the sender manually selects RGB printing colour (0,1,0) 57 for the second portion of the template. This template is optionally checked using the checking procedure outlined below, then saved for future use.

The sender next inserts values into the first and second portions of the template. In the running example, the “debtor” value is “XYZ Corp.” and the “amount payable” value is “$100.00”. Hence, the sender inputs these values respectively into the first and second portions of the template. The insertion of these values creates an invoice 55, which is printed to a virtual printer. In this preferred embodiment, the virtual printer creates a PDF file.

The electronic form (i.e. invoice 55) is then communicated from the sender to the recipient. More particularly, the PDF file is sent as data stream 58 from modem 59 on the sender's computer 50 to modem 60 on the recipient's computer 56.

Once received at the recipient's computer 56, the invoice 55 is processed so as to extract the values associated with each of the printing colours 53 and 57. That is, the recipient's computer processes the invoice 55 and determines that “XYZ Corp.” has been printed in RGB printing colour (0,0,1) and “$100.00” has been printed in RGB printing colour (0,1,0).

The recipient's computer 56 also has access to the data correlation scheme 51, either via a functionally identical version, as shown in FIG. 4, or via remote access to the original version. The recipient's computer 56 then processes the data correlation scheme 51 and the printing colours 53 and 57 so as to correlate the values with the chosen data fields 52 and 54. That is, the recipient's computer refers to the data correlation scheme 51 to determine that RGB printing colour (0,0,1) correlates with the “debtor” field 52 and (0,1,0) correlates with the “amount payable” field 54. Hence, the recipient's computer determines that the value “XYZ Corp.” falls within the “debtor” field 52 and the value “$100.00” falls within the “amount payable” field 54. In this manner, two separate computer systems, 50 and 56, possibly utilising different applications that are not inherently compatible with each other, utilise the present invention for effective communication of data there between.

An optional further step involves converting all colours within the fields 52 and 54 of a form to a single standard colour, for example pure black. In doing so, the embedded information regarding the field-types is lost. This option is particularly useful for implementations of the invention in which a very large number of different field-types are used. In such a situation, the range of indistinguishable printing colours may be exhausted and it may therefore be necessary to utilise printing colours that discernibly differ visually from the standard colour.

In alternative embodiments each field is correlated with more than one RGB printing colour. In one such alternative embodiment, any given field is correlated with a range of RGB printing colours, for example a single field is correlated with a range such as (0,0,1) to (0,0,5). This option is particularly advantageous if the virtual printing process results in minor shifting of the exact colour value, for example due to so-called “colour correction”.

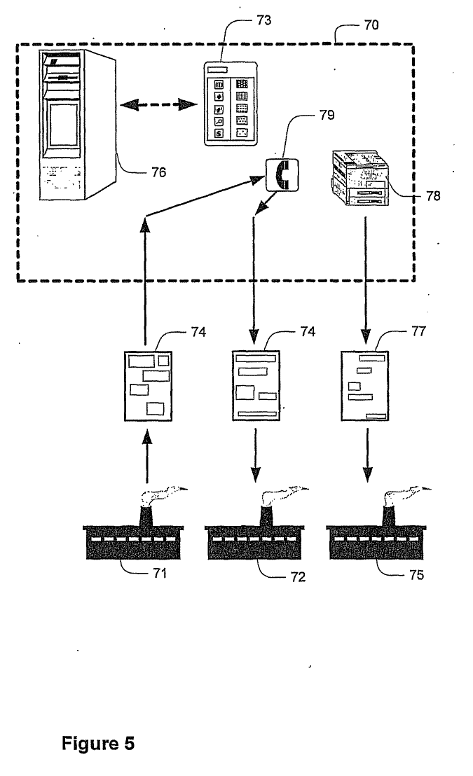

FIG. 5 illustrates a communication processing method in which communications hub 70 stores information in the form of a database of registered users. The database identifies a plurality of registered users 71 and 72, each registered user being adapted to utilise the data correlation scheme 73.

By way of example, two types of communication will be described. In the first type of communication, a first registered user 71 sends an electronic form 74 to a second registered user 72. In the second type of communication, first registered user 71 sends a form to an unregistered entity 75. Unregistered entities are those entities that are not adapted to utilise the data correlation scheme 73.

In the first type of communication, first user 71 sends an electronic form 74 that has field-portions that been formatted with specific printing colours in the manner previously described. A data stream representing this form 74 is received by the hub's modem 79. The hub processor 76 processes the form 74 to determine the intended recipient, which in this case is registered user 72. The hub processor 74 determines the intended recipient by firstly determining from the data correlation scheme 73 which printing colour is associated with the “recipient” field. This allows the hub processor 76 to extract the recipient's details from the form 74, as those details are printed on the form 74 in the relevant printing colour. The hub processor 76 then interrogates the database of registered users to determine whether the recipient is adapted to utilise the data correlation scheme 73 and in this case the answer is affirmative. Hence, the hub 70 electronically forwards the electronic form 74 to the registered user 72. The registered user's computer then extracts the values and associated data fields from the electronic form 74 in the manner previously described. However, in an alternative embodiment, the hub processor 76 extracts the values and associated data fields from the electronic form 74 in the manner previously described and this extracted information is electronically sent to the registered user 72, either with, or in the place of, the electronic form 74.

In the second type of communication, the first user 71 sends an electronic form 74 that has been formatted with specific printing colours to the hub 70. The hub processor 76 processes the form 74 to determine the intended recipient, which in this case is unregistered entity 75. The hub processor 76 then interrogates the database of registered users to determine whether the recipient is adapted to utilise the data correlation scheme 73 and in this case the answer is negative. Hence, the hub 70 uses printer 78 to print a physical copy 77 of the form 74, which is posted from the hub 70 to the unregistered entity 75 via conventional mail. In an alternative embodiment, the physical copy 77 is posted to a third party via conventional mail. In yet another embodiment the hub 70 electronically returns the electronic form 74 to the sender 71 in the event that the recipient is not adapted to utilise the data correlation scheme 73.

The communications hub 70 includes data storage means in which a copy of all electronic forms received at hub 70 are. archived.

The hub 70 is also configured to check whether test templates and forms are suitable for use with the data correlation scheme 73. The test process commences with creation of a test document, upon which field portions are coloured with the required printing colours in accordance with the data correlation scheme. Additional formatting of the test document may also entail the usage of other colours, for example to print company logos and the like. The test document is then sent to the hub 70, which performs a check of each of the colours utilised in the test document. The aim of the check is to ensure that printing colours from the data correlation scheme have not been inadvertently used in a non-field context on the test document. The hub 70 then communicates the results of the test to the entity that submitted the test document. If the result is positive, the entity can safely use the template or form. However, if the result is negative, corrections to the template or form will be required. In such a case, the hub test results highlight the offending colour usage on the test document to assist with the correction process.

An alternative embodiment of the invention makes use of more than one data correlation scheme 73. In this embodiment, each form 74 submitted to the hub 70 includes a schema indicator embedded within the document. The schema indicator is an alphanumeric string, printed onto the document in a predefined printing colour. The alphanumeric string is extracted by the hub processor 76 and used to identify the specific data correlation scheme to be applied during extraction of the remaining data from the form 74.

Figure six schematically depicts a transaction method for the purchase of goods from a seller 86 by a buyer 87. The method makes use of a data correlation scheme 88 whereby a plurality of data fields are respectively correlated with a corresponding plurality of printing colours. The method commences with receipt by the seller 86 of an order for goods by the buyer 87. In one embodiment the order is communicated from the buyer 87 to the seller 86 via the communications hub 89 and the fields in the order are coloured by the buyer 87 in accordance with the data correlation scheme 88. However, in alternative embodiments the order is communicated by other means, such as by telephone, post, via the internet, etc.

For the sake of a running example with reference to this preferred embodiment, the buyer, XYZ Corp, orders five, size 10, Brand X, running shoes at a unit cost of $40.00 from seller, ABC Corp.

Upon receipt of the order, the seller prints a form 90 including goods delivery data contained within seven preselected data fields, as follows:

| Preselected Fields | Goods Delivery Data |
|---|---|
| Purchaser | XYZ Corp. |
| Supplier | ABC Corp. |
| Quantity | 5 |
| Size | 10 |
| Brand | X |
| Goods Description | Running Shoes |
| Total Purchase Price | $200.00 |

Each element of the goods delivery data is printed onto the form 90 in a specific printing colour, based on the relevant preselected field, in accordance with the data correlation scheme 88. The form 90 is printed to a virtual printer to create a print file. The print file is then communicated in data stream 91 from the seller 86 to the modem 98 at the communications hub 89.

In an alternative embodiment, the form 90 is created on the sender's computer and the sender then prints the form 90 to a remote virtual printer provided at the hub 89.

The hub processor 92 processes the form 90 to extract said goods delivery data. This is achieved by extracting all data from the form 90 that is printed in any of the specific printing colours and using the data correlation scheme 88 to correlate each of the fields with the respective goods delivery data. Once extracted, the hub processor determines a unique identifier, which is an ID number 93. The hub 89 then stores the goods delivery data in association with the ID number 93 for later use.

The ID number 93 is converted into bar code format and communicated from the hub 89 to the seller 86 via data stream 94. In some embodiments a copy of the form 90 is also communicated from the hub 89 to the seller 86, along with the bar code. This facilitates manual handling during system outages and may be of assistance to entities that are not registered users of the transaction method.

Upon receipt of the bar code, the seller 86 physically prints the bar code onto a piece of paper that is attached, or otherwise physically associated with the goods 95. The goods 95, and associated bar code, are then dispatched 96 by the seller 86 for delivery to the buyer 87.

Upon receipt of the goods 95, the buyer 87 scans the bar code and communicates it to the hub 89 via data stream 97. This is received and processed by the hub processor 92, thereby allowing for retrieval of the previously stored goods delivery data associated with the unique identifier. The retrieved goods delivery data is then communicated from the hub 89 to the buyer 87. Upon receipt of this information, the buyer can easily reconcile the goods as received against the original order.

Although the present invention has been described with particular reference to certain embodiments thereof, further variations and modifications can be effected within the spirit and scope of the invention.

What is claimed is:

1-25. (canceled)

26. A method for communication of data between a sender and a recipient, the method comprising:
(i) providing a data correlation scheme whereby a plurality of data fields are respectively correlated with a corresponding plurality of printing colours;
(ii) printing an electronic form having at least one value within at least one preselected data field, the value being printed in a printing colour determined in accordance with the data correlation scheme;
(iii) communicating the electronic form from the sender to the recipient;
(iv) processing the electronic form so as to determine the value and the printing colour; and
(v) processing the data correlation scheme and the printing colour so as to correlate the value with the preselected data field.

27. A method according to claim 26 wherein the printing colour is manually selectable by a user.

28. A method according to claim 27 wherein the printing colour is manually selectable by the specification of three numeric values in an RGB colour format.

29. A method according to claim 26 wherein the plurality of printing colours includes a first colour that is a visually imperceptible variation of a second colour.

30. A method according to claim 26 wherein the step of printing an electronic form includes the steps of:
(a) preparing a blank form template;
(b) defining a portion of the blank form template for receipt of the at least one value within at least one preselected data field;
(c) formatting the portion in the printing colour;
(d) inserting the at least one value into the portion; and
(e) printing the form to an electronic document.

31. A method according claim 26 further including the step of converting the colour or colours of the at least one value to a single standard colour.

32. A method for processing an electronic form, the method comprising:
(i) receiving the electronic form;
(ii) determining whether the electronic form was prepared in accordance with a data correlation scheme whereby a plurality of data fields are respectively correlated with a corresponding plurality of printing colours;
(iii) processing the form to identify at least one value being printed in a printing colour determined in accordance with the data correlation scheme;
(iv) on the basis of the data correlation scheme, determining the data field correlated with the printing colour of the identified value; and
(v) providing the value to a database on the basis of the determined data field.

33. A method according to claim 32 wherein the plurality of printing colours includes a first colour that is a visually imperceptible variation of a second colour.

34. A communication processing method including the steps of:
(i) receiving, from a sender party, an electronic form, the form including at least one value being printed in a printing colour in accordance with a data correlation scheme, the data correlation scheme associating a plurality of data fields with a corresponding plurality of printing colours;
(ii) processing the form to determine a recipient party;
(iii) querying a database of parties adapted to utilise the data correlation scheme to determine whether the recipient party is adapted to utilise the data correlation scheme;
(iv) in the case that the recipient is adapted to utilise the data correlation scheme, processing the form so as to extract the at least one value and the at least one preselected data field associated with the printing colour for that value; and
(v) electronically communicating data indicative of the at least one value and the at least one preselected data field to the recipient party.

35. A communication processing method according to claim 34 wherein, in the case that the recipient party is not adapted to utilise the data correlation scheme, the electronic form is provided to the recipient party.

36. A communication processing method according to claim 34 wherein, in the case that the recipient party is not adapted to utilise the data correlation scheme, the electronic form is returned to the sender party.

37. A communication processing method according to claim 34 further including the step of archiving a copy of the electronic form.

38. A computer-readable carrier medium carrying a set of instructions that when executed by one or more processors cause the one or more processors to carry out a method comprising:
assigning a first data rank from the table to a portion of information in a document;
querying a table that associates one or more data ranks each with a respective digital attribute for determining a first digital attribute associated with the first data rank; and
outputting the document in a data stream wherein the associated digital attribute is implanted in the portion of information, such that the portion of information and assigned data rank are electronically extractable from the document in a computer system having access to the table.

39. A computer-readable carrier medium according to claim 38 wherein the digital attributes are printing colours.

40. A computer-readable carrier medium according to claim 39 wherein the printing colours include a first colour that is a visually imperceptible variation of a second colour.

41. A computer-readable carrier medium according to claim 38 wherein the digital attributes include a first digital attribute that is a visually imperceptible variation of a second digital attribute.

42. A computer-readable carrier medium according to claim 38 wherein the each digital attribute includes a chromatic marker.

43. A computer-readable carrier medium according to claim 42 wherein the chromatic marker includes a variation of RGB colour.

44. A computer-readable carrier medium according to claim 43 wherein the variation is substantially visually imperceptible.

45. A computer-readable carrier medium carrying a set of instructions that when executed by one or more processors cause the one or more processors to carry out a method comprising:
receiving a document in a data stream;
determining whether a portion of information in the document has an implanted digital attribute;
querying a table that associates one or more data ranks each with a respective digital attribute for determining an assigned data rank associated with the implanted digital attribute;
extracting the portion of information and the assigned data rank from the document; and
on the basis of the assigned data rank, providing the portion of information to a location.

46. A computer-readable carrier medium according to claim 45 wherein the location includes
a database;
an information system;
a secondary document; and
a communication package.

47. A computer-readable carrier medium according to claim 45 wherein the digital attributes comprise printing colours.

48. A computer-readable carrier medium according to claim 45 wherein the digital attributes comprise a first digital attribute that is a visually imperceptible variation of a second digital attribute.

49. A computer-readable carrier medium according to claim 45 wherein the digital attribute comprises a chromatic marker.

50. A computer-readable carrier medium according to claim 49 wherein the chromatic marker includes a variation of RGB colour.
